(19) United States
(12) Patent Application Publication
(10) Pub. No.: US 2026/0305581 A1
(43) Pub. Date: Oct. 8, 2026

(54) AUTOMATIC DOOR DEVICE

(71) Applicant: Chunfeng ZHANG, Shenzhen (CN)

(72) Inventor: Chunfeng ZHANG, Shenzhen (CN)

(21) Appl. No.: 19/320,033

(22) Filed: Sep. 5, 2025

(30) Foreign Application Priority Data
Apr. 3, 2025 (CN) 202520627874.3

(51) Int. Cl. A01K 31/02; A01K 31/10; E05F 15/665; E05F 15/77

(52) U.S. Cl. CPC A01K 31/02; A01K 31/10; E05F 15/665; E05F 15/77; E05Y 2900/132

(57) ABSTRACT

An automatic door device is applied to a breeding house, and includes an automatic door and a lifting structure. The automatic door includes a door frame and a door plate. The door frame includes a top beam and two side beams. An entrance is formed by the two side beams and the top beam. The door plate includes a door plate body and at least one sliding-guided structure. Each sliding-guided structure is coupled to the door plate body to form a sliding-guided groove slidingly cooperated with an associated side beam; or, each sliding-guided structure is provided with a sliding-guided groove slidingly cooperated with an associated side beam. The lifting structure is mounted on the top beam, and configured to drive the door plate body to drive the at least one sliding-guided structure to slide against the door frame to open or close the entrance.

### CROSS-REFERENCE TO RELATED APPLICATION

The present disclosure claims priority to and the benefit of Chinese Application Patent Serial No. 202520627874.3, filed with the Chinese Patent Office on Apr. 3, 2025. The disclosures of the aforementioned disclosures are hereby incorporated by reference in their entireties.

### TECHNICAL FIELD

The present disclosure relates to the technical field of an apparatus for raising livestock, and in particular to an automatic door device.

### BACKGROUND

In existing automatic door devices, the door plate slides within a longitudinal groove provided on the door frame to restrict vertical movement of the door plate relative to the door frame. However, the longitudinal groove is provided on the door frame, increasing the structural complexity and cleaning difficulty of the door frame, resulting in higher costs, generating significant friction noise when the door plate moves up and down relative to the door frame, and thereby reducing the user experience.

### SUMMARY

In view of the above, an objective of the present disclosure is to provide an automatic door device of the existing automatic door device to solve the technical problems that the longitudinal groove is provided on the door frame, increasing the structural complexity and cleaning difficulty of the door frame, resulting in higher costs, generating significant friction noise when the door plate moves up and down relative to the door frame, and thereby reducing the user experience.

The present disclosure provides an automatic door device is applied to a breeding house. The automatic door device includes an automatic door and a lifting structure. The automatic door includes a door frame and a door plate. The door frame is configured to be mounted on an edge of a passageway opening of the breeding house. The door frame includes a top beam and two side beams. The two side beams are coupled to two ends of the top beam in a lengthwise direction of the door plate, respectively. An entrance is formed by the two side beams and the top beam. The door plate includes a door plate body and at least one sliding-guided structure. Each of the at least one sliding-guided structure is coupled to the door plate body, a sliding-guided groove is formed by each of the at least one sliding-guided structure and the door plate body, and is slidingly cooperated with an associated side beam; or, each of the at least one sliding-guided structure is provided with a sliding-guided groove slidingly cooperated with an associated side beam. The lifting structure is mounted on the top beam. The lifting structure is configured to drive the door plate body to drive the at least one sliding-guided structure to slide against the door frame to open or close the entrance.

The present disclosure provides the automatic door device, on one hand, the door plate body is provided with the at least one sliding-guided structure, and each of the at least one sliding-guided structure is coupled to the door plate body to form the sliding-guided groove slidingly cooperated with the associated side beam; or, each of the at least one sliding-guided structure is provided with the sliding-guided groove slidingly cooperated with the associated side beam, thus achieving the door plate body to move vertically relative to the door frame by sliding cooperation with the sliding-guided groove and the door frame, improving reliability and stability in operating the door plate to open and close the entrance, simplifying a structure of the door frame, reducing manufacturing complexity and cleaning difficulty of the door frame, lowering costs, reducing friction noise and vibration generated during vertical movement of door plate relative to door frame, and thereby improving user experience and a smooth operation of door plate, and on the other hand, the lifting structure drives the door plate body to move up and down relative to the door frame, thus achieving automatic opening and closing of the door plate, and improving the efficiency and safety of livestock management.

### BRIEF DESCRIPTION OF THE DRAWINGS

In order to describe the technical solutions in the present disclosure more clearly, the accompanying drawings required to be used in the implementations will be simply introduced below. It is apparent that the accompanying drawings in the following descriptions are only some implementations of the present disclosure. Those of ordinary skill in the art may further obtain other apparent variations according to these accompanying drawings without creative work.

FIG. 1 is a structural schematic view of an automatic door device mounted on a breeding house according to a first embodiment of the present disclosure.

FIG. 2 is a front view of the automatic door device shown in FIG. 1.

FIG. 3 is a sectional view of the automatic door device taken along line I-I of FIG. 2.

FIG. 4 is a sectional view of a partial structure of the automatic door device taken along line II-II of FIG. 2.

FIG. 5 is a structural schematic view of a front view of the automatic door device shown in FIG. 1 in which the automatic door device is in a closed state.

FIG. 6 is a structural schematic view of a front view of the automatic door device shown in FIG. 1 in which the automatic door device is in an open state.

FIG. 7 is a top view of the automatic door device shown in FIG. 1.

FIG. 8 is a schematic view of a rear view of a partial structure of the automatic door device in a closed state provided by a second embodiment of the present disclosure.

FIG. 9 is a sectional view of a partial structure of the automatic door device in FIG. 8.

FIG. 10 is a sectional view of a partial structure of the automatic door device provided by a third embodiment of the present disclosure.

FIG. 11 is a schematic view of a partial structure of the automatic door device provided by a fourth embodiment of the present disclosure.

FIG. 12 is a cross-sectional view of a partial structure of the automatic door device shown in FIG. 11.

FIG. 13 is a cross-sectional view of a partial structure of the automatic door device provided by a fifth embodiment of the present disclosure.

FIG. 14 is a cross-sectional view of a second wireless control structure of the automatic door device shown in FIG. 2.

FIG. 15 is a structural schematic view of a rear view of the second wireless control structure of the automatic door device shown in FIG. 2.

The following specific embodiments will further illustrate the present disclosure in conjunction with the above accompanying drawings.

### DETAILED DESCRIPTION

The technical solutions in the implementations of the present disclosure are clearly and completely described in the following in conjunction with the accompanying drawings of the present disclosure. It is apparent that the described implementations are only part of the implementations of the present disclosure, not all of the implementations. On the basis of the implementations of the present disclosure, all other implementations obtained on the premise of no creative work of those of ordinary skill in the art shall fall within the scope of protection of the present disclosure.

It should be appreciated that the terms in the specification and the claims of the present disclosure and the above-described accompanying drawings are used only to describe a particular embodiment, and are not intended to limit the present disclosure. The terms “first” and “second” in the specification and claims of the present disclosure and the above-described accompanying drawings are used to distinguish between different objects, and are not used to describe a particular order. The singular forms “one” and “the” are also intended to include the plural form unless the context clearly indicates otherwise. The term “including”, and any variations thereof, is intended to cover non-exclusive inclusion. In addition, the present disclosure can be realized in many different forms and is not limited to the embodiments described herein. The following specific embodiments are provided to facilitate a clearer and more thorough understanding of the disclosure of the present disclosure, wherein the terms indicating orientation such as up, down, left, and right, are directed only to the position of the structure shown in the corresponding accompanying drawings. In the description of the present disclosure, it is to be noted that, unless otherwise expressly provided and limited, the terms “mounted”, “connected”, “connected”, “arranged on . . . ”, and “provided with” are to be understood in a broad sense. Exemplarily, the elements may be fixedly connected, detachably connected, or integrally connected. The elements may be mechanically connected. The elements may be directly connected, or indirectly connected through an intermediate medium. For a person of ordinary skill in the art, the specific meaning of the above terms in the present disclosure can be understood in specific cases.

The subsequent description in the specification is provided as an exemplary embodiment of the present disclosure. However, the above description is intended to illustrate the general principles of the present disclosure and is not intended to limit the scope of the present disclosure. The scope of protection of the present disclosure shall be determined by the appended claims. The present disclosure will now be described in further detail with reference to the accompanying drawings.

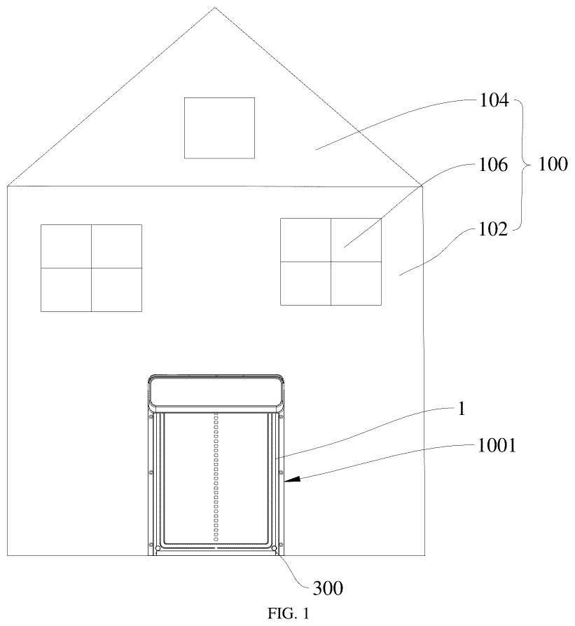

As illustrated to FIG. 1, FIG. 1 is a structural schematic view of an automatic door device 300 mounted on a breeding house 100 according to a first embodiment of the present disclosure. The breeding house 100 is provided with a passageway opening 1001. The passageway opening 1001 is configured for animals or livestock personnel to enter or exit. The automatic door device 300 is mounted at the passageway opening 1001, thus the breeding house 100 may automatically open or close the passageway opening 1001 by the automatic door device 300, thereby improving the efficiency and safety of livestock management.

The breeding house 100 is an enclosed or semi-enclosed apparatus, and is configured to be centralized feeding and management of animals. The breeding house is commonly used in animal husbandry and farming. The animals may be, but are not limited to, chickens, ducks, rabbits, cows, sheep, and the like. The breeding house 100 may be, but is not limited to, a chicken coop, a duck coop, a rabbit coop, a cow coop, a sheep coop, and the like. Understandably, in order to enable the person skilled in the art to better understand the automatic switch device 300, the first embodiment of the present disclosure is illustrated in detail by an example of the automatic switch device 300 being applied to the chicken coop. It is to be noted that the application scenario of the automatic switch device 300 as the chicken coop is only used for illustration purposes, the present disclosure is not specifically limited, and the type of the application scenario of the automatic switch device 300 may be set according to actual needs.

Exemplarily, in the embodiment, the breeding house 100 may include a breeding body 102 and a breeding cover 104. The breeding cover 104 is arranged over the breeding body 102. The breeding body 102 may be, but is not limited to, an enclosure or a fence, etc. At least one of the enclosure body 102 and the breeding cover 104 is provided with a ventilation window 106, thus facilitating the exchange of indoor and outdoor air in the breeding house 100, keeping the air fresh, and enhancing the comfort of the animal's residence. Of course, in some embodiments, the breeding house 100 may omit the breeding cover 104, i.e., the breeding house 100 includes only the breeding body 102.

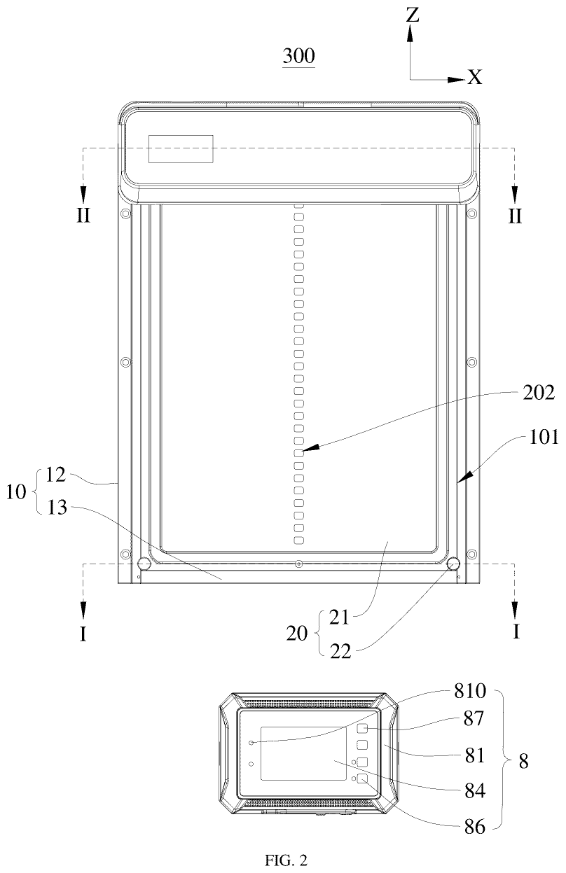

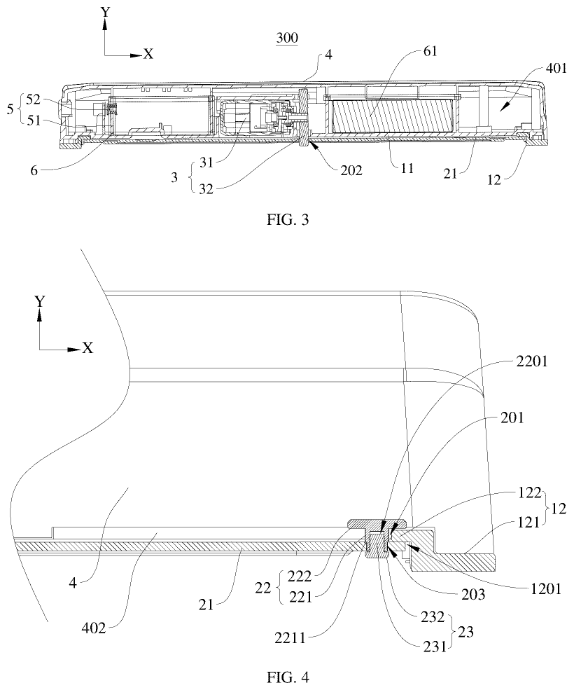

As illustrated to FIG. 2 to FIG. 4, FIG. 2 is a front view of the automatic door device 300 shown in FIG. 1, FIG. 3 is a sectional view of the automatic door device 300 taken along line I-I of FIG. 2, and FIG. 4 is a sectional view of a partial structure of the automatic door device 300 taken along line II-II of FIG. 2. The automatic door device 300 includes an automatic door 1 and a lifting structure 3. The automatic door 1 includes a door frame 10 and a door plate 20. The door frame 10 is configured to be mounted on an edge of a passageway opening 1001 of the breeding house 100. The door frame 10 includes a top beam 11 and two side beams 12. The two side beams 11 are coupled to two ends of the top beam 11 in a lengthwise direction X of the door plate 20, respectively. An entrance 101 is formed by the two side beams 12 and the top beam 11. The door plate 20 includes a door plate body 21 and at least one sliding-guided structure 22. Each of the at least one sliding-guided structure 22 is coupled to the door plate body 21. A sliding-guided groove 201 is formed by each of the at least one sliding-guided structure 22 and the door plate body 21, and is slidingly cooperated with an associated side beam 12; or, each of the at least one sliding-guided structure 22 is provided with a sliding-guided groove 201 slidingly cooperated with an associated side beam 12. The lifting structure 3 is mounted on the top beam 11. The lifting structure 3 is configured to drive the door plate body 21 to drive the at least one sliding-guided structure 22 to slide against the door frame 10 to open or close the entrance 101.

The present disclosure provides the automatic door device 300, on one hand, the door plate body 21 is provided with the at least one sliding-guided structure 22, and each of the at least one sliding-guided structure 22 is coupled to the door plate body 21 to form the sliding-guided groove 201 slidingly cooperated with the associated side beam 12; or, each of the at least one sliding-guided structure 22 is provided with the sliding-guided groove 201 slidingly cooperated with the associated side beam 12, thus achieving the door plate body to move vertically relative to the door frame by sliding cooperation with the sliding-guided groove 201 and the door frame 10, improving reliability and stability in operating the door plate 20 to open and close the entrance 101, simplifying a structure of the door frame 10, reducing manufacturing complexity and cleaning difficulty of the door frame 10, lowering costs, reducing friction noise and vibration generated during vertical movement of door plate 20 relative to door frame 10, and thereby improving user experience and a smooth operation of door plate 20, and on the other hand, the lifting structure 3 drives the door plate body 21 to move up and down relative to the door frame 10, thus achieving automatic opening and closing of the door plate 20, and improving the efficiency and safety of livestock management.

For accuracy of description, As illustrated to FIG. 1 and FIG. 2 whenever orientation is involved herein. The door plate 20 is configured as a rectangular door plate. The term “length direction X” refers to a direction that is parallel to a short side of the door plate 20, i.e., the left and right directions in FIG. 2. The term “height direction Z” refers to a direction perpendicular to a carrying surface of the automatic door device 300, that is a direction parallel to a long side of the door plate 20, i.e., the up and down directions in FIG. 2. The term “thickness direction Y” refers to a direction perpendicular to both the length direction X and the height direction Z; in other words, the thickness direction Y is parallel to an opening direction of the entrance 101, i.e., the up and down directions in FIG. 3. In particular, the length direction X, the width direction Y and the thickness direction Z together constitute three orthogonal directions of the automatic door device 300. For the convenience of description, the length direction X, the width direction Y and the thickness direction Z in present disclosure are relative positions and do not constitute a limitation to realize the limitation. The length direction X, the width direction Y and the thickness direction Z can be customized according to the specific structure of the product and the perspective presented in the accompanying drawings, and the present disclosure is not specifically limited.

It is to be noted that FIG. 2 is intended only to schematically depict the arrangement between the door frame 10, the door plate 20, and the lifting structure 3, and is not intended to make specific limitations on the connection positions, connection relationships and specific constructions of the individual components. FIG. 2 is only a structure of the automatic door device 300 schematically illustrated by an embodiment of the present disclosure, and does not constitute a specific limitation of the automatic door device 300. In other embodiments of the present disclosure, the automatic door device 300 may include more or fewer components than those shown in FIG. 2, or a combination of certain components, or different components. Exemplarily, the automatic door device 300 may also include, but is not limited to, a safety lock, a protection module, and the like. The safety lock is configured to unlock a switch of the automatic door device 300, thus preventing accidental triggering of the automatic door device 300 and enhancing the safety of its operation. The protection module is mounted on the door frame 10. The protection module may be, but is not limited to, rubber, sponge, etc. thus preventing the door frame 10 from scratching the animals.

Exemplarily, in the embodiment, the door plate 20 includes two of the guide slide structures 22. That is, the guide slide structure 22 is provided as two in number. The two guide slide structures 22 are respectively positioned at two corners at a bottom of the door plate 20. On one hand, it prevents the two sliding-guided structures 22 from disconnecting from the two side beams 12 when the two opens the entrance 101, thus ensuring reliable alignment and assembly between the door plate 20 and the door frame 10, and on the other hand, a size of the entrance 101 may be maximized without while the two sliding-guided structures 22 detaching from its connection to the two side beams 12.

In some embodiments, the door plate 20 includes a plurality of sliding-guided structures 22. Two sliding-guided structures 22 are arranged oppositely along the length direction X of the door plate 20, and form a sliding-guided assembly. The sliding-guided assembly is provided as one or more in number. the door plate 20 includes a plurality of sliding-guided assemblies, the plurality of sliding-guided assemblies are arranged at intervals along the height direction Z of the door plate 20, thus enhancing the reliability and stability of the vertical movement of the door plate 20 relative to the door frame 10

Exemplarily, in the embodiment, the lifting structure 3 is configured to drive the door plate 20 to move up and down relative to the door frame 10 along the height direction Z of the door plate 20, thus saving a space occupied by the door plate 20 in the horizontal direction, and improving the wind resistance of the door plate 20. In addition, when the door plate 20 is subjected to strong winds, the door plate 20 is less likely to deform, thus extending the service life of the automatic door device 300. The translational direction of the door plate 20 is parallel to the height direction Z of the door plate 20.

The lifting structure 3 includes a driving member 31 and a transmitting member 32. The transmitting member 32 is force-transmittingly coupled to the door plate body 21. The driving member 31 is configured to drive the transmitting member 32 to lift and lower the door plate body 21 relative to the door frame 10. Exemplarily, in the embodiment, the door plate body 21 is provided with a plurality of connecting holes 202. The plurality of connecting holes 202 are arranged at intervals along the height direction Z of the door plate 20. The transmitting member 32 is configured as a gear and meshes with the plurality of connecting holes 202. Such that, the driving member 31 is configured to drive the transmitting member 32 to rotate, and the rotation of the transmitting member 32 causes the door plate body 21 to open or close the entrance 101. Consequently, the transmitting member 32 force-transmittingly is meshed with each of the plurality of connecting holes 202, on a first hand, reducing vibration and impact, improving the smoothness and precision of the door plate 20 movable relative to the door frame 10, and extending the service life of the automatic door device 300; on a second hand, simplifying the transmission structure between the transmitting member 32 and the connecting hole 202, making maintenance more convenient, and enabling the lifting structure 3 to withstand heavy loads; and on a third hand, improving transmission efficiency between the transmitting member 32 and connection hole 202, and reducing energy loss and lowering operating costs. Of course, in other embodiments, the transmitting member 32 may also be configured with a chain or other transmission structure, and the present disclosure does not make specific limitations.

The lifting structure 3 is mounted on the top beam 11, thus preventing animals or caretakers from accidentally touching the lifting structure 3, reducing safety hazards of the automatic door device 300, and minimizing corrosion of electrical components such as the lifting structure 3 caused by ground dust, moisture, and manure, and thereby extending the service life of the automatic door device 300. Of course, in some embodiments, the lifting structure 3 may also be positioned on at least one of the two side beams 12 or other portions of the automatic door device 300, and the embodiments of the present disclosure do not impose specific limitations.

Exemplarily, in the embodiment, the driving member 31 and the transmitting member 32 are arranged at a middle of the top beam 11, thereby improving the uniformity of force distribution on the top beam 11, and achieving a compact structure. The material of the door frame 10 may include but is not limited to at least one of steel, wood, or alloy. The door frame 10 is configured as a support structure for the lifting structure 3, thus enhancing the stability and reliability of the lifting structure 3 in operation. Exemplarily, in the embodiment, the door frame 10 is made of steel, thus providing advantages such as strength, durability, and fire resistance, as well as ease of maintenance and cleaning.

The door frame 10 is mounted at an edge of the entrance 1001 of the breeding house 100. Exemplarily, in the embodiment, the door frame 10 is detachably coupled to the breeding house 100, facilitating assembly, maintenance, and replacement of the automatic door device 300. Of course, in some embodiments, the door frame 10 and the breeding house 100 may be integrally formed, and the present disclosure does not make specific limitations.

Exemplarily, in the embodiment, the door plate 20 further includes at least one mounting member 23. The at least one mounting member 23 and the at least one sliding-guided structure 22 are arranged in a one-to-one correspondence. Each of the at least one sliding-guided structure 22 is arranged independent from the door plate body 21, and is detachably mounted on the door plate body 21 by an associated mounting member 23. Understandably, since a thickness of the door plate body 21 is relatively thin, a connection length between the sliding-guided structure 22 and the door plate body 21 is relatively short. Such that the direct connection between the door plate body 21 and each of the at least one sliding-guided structure 22 is prone to detachment issues. Therefore, on a first hand, each of the at least one sliding-guided structure 22 is detachably mounted on the door plate body 21 by the associated mounting member 23, thus improving the connection strength and stability between the door plate body 21 and the at least one sliding-guided structure 22, reducing a risk of failures caused by loose connections, and improving the overall performance and service life of the door plate 20; on a third hand, each of the at least one sliding-guided structure 22 is arranged independent from the door plate body 21, thus reducing the manufacturing difficulty of the door plate body 21; and on a third hand, each of the at least one sliding-guided structure 22 is detachably mounted on the door plate body 21, thus facilitating replacement, cleaning, and maintenance of both the door plate body 21 and each of the at least one sliding-guided structure 22. Of course, in some embodiments, the at least one mounting member 23 may be omitted, i.e., the each of the at least one sliding-guided structure 22 and the door plate body 21 are integrally formed, thereby enhancing the connection strength between each of the at least one sliding-guided structure 22 and the door plate body 21.

In the embodiment, the at least one sliding-guided structure 22 is fixedly coupled to the door plate body 21 by the associated mounting member 23. The arrangement of the at least one sliding-guided structure 22 may enhance the structural rigidity of the door plate body 21, thus improving the stability of the door plate body 21 when moving up and down relative to the door frame 10. Additionally, there is no accumulation of rotational freedom errors between the at least one sliding-guided structure 22 and the door plate body 21, thus enhancing the positioning accuracy of the fit between the door plate 20 and the door frame 10. Furthermore, no lubrication is required for the sliding-guided structure 22, thus resulting in low maintenance costs.

Each of the at least one sliding-guided structure 22 includes a connecting portion 221 and an extending portion 222. In some embodiments, in the same sliding-guided structure 22, one end of the connecting portion 221 is coupled to the door plate body 21 by the associated mounting member 23, the extending portion 222 is provided as one in number, and the extending portion 222 is coupled to an another end of the connecting portion 221, and the sliding-guided groove 201 is formed by the extending portion 222, the connecting portion 221, and the door plate body 21. Consequently, on one hand, material usage is reduced, costs are saved, the weight of the door plate 20 is reduced, lightweight design for the door plate 20 is achieved, and an issue of reducing structural strength by directly machining grooves in the door plate 20 is avoided; On the other hand, the extending portion 222 is bent relative to the connecting portion 221, forms the sliding-guided groove 201 with the door plate body 21, thereby reducing the assembly adjustment time between the at least one guide structure 22 and the door plate body 21, and improving assembly efficiency between the at least one guide structure 22 and the door plate body 21. Exemplarily, in the embodiment, each of the at least one guide structure 22 is configured as a L-shaped structure. Specifically, the connecting portion 221 is configured as a columnar structure, and the extending portion 222 is configured as a plate-shaped structure.

Specifically, the door plate body 21 is provided with a through hole 203. The connecting portion 221 of each of the at least one sliding-guided structure 23 is provided with a mounting hole 2201. Specifically, an end of the connecting portion 221 facing away from the extending portion 222 is provided with a mounting hole 2201. The connecting portion 221 is inserted into one side of the through hole 203, the mounting hole 2201 is exposed on an another side of the through hole 203. The mounting member 23 is locked in the mounting hole 2201, and the connecting portion 221 has an interference fit with the mounting hole 2201. The mounting member 23 is locked within the mounting hole 2201 and expands connecting portion 221 to achieve an interference fit between the connecting portion 221 and the mounting hole 2201, thus achieving a fixed connection between each of the at least one guide structure 22 and the door plate body 21.

In some embodiments, each of the at least one mounting member 23 includes a locking portion 231 and a stopping portion 232. In the same mounting member 23, the locking portion 231 is locked in the mounting hole 2201, the stopping portion 232 is coupled to one end of the locking portion 231 and configured to stop against the door plate body 21. That is, the locking portion 231 of an associated mounting member 23 is locked in the mounting hole 2201, and the stopping portion 232 of the associated mounting member 23 is coupled to one end of the locking portion 231, and is configured to stop against the door plate body 21. Such that a risk of loosening between the door plate body 21 and each of the at least one guide structure 22 may be reduced. Additionally, the stopping portion 232 of an associated mounting member 23 is configured to protrude relative to the door plate body 21, thus facilitating disassembly operations.

In some embodiments, a limiting step 2211 is provided on the connecting portion 221. The limiting step 2211 is configured to limit an insertion depth of the connecting portion 221 into the mounting hole 2201, thus facilitating assembly. Additionally, the limiting step 2211 cooperates with the stopping portion 232 to limit the at least one sliding-guided structure 22 from moving along the thickness direction Y of the door plate 20, thus enhancing the reliability and stability of the connection between the at least one sliding-guided structure 22 and the door plate body 21.

In the embodiment, the extending portion 222 is extended around a circumferential direction of the connecting portion 221. In other words, each of the at least ones sliding-guided structure 22 is configured as a T-shaped structure, such as a rivet structure. Specifically, the connecting portion 221 is configured as a columnar structure, and the extending portion 222 is configured as a disc structure. Consequently, on one hand, after each of the at least ones sliding-guided structure 22 rotates relative to the door plate body 21, the extending portion 222 can still form a sliding-guided groove 201 together with the connecting portion 221 and the door plate body 21, thus enhancing the reliability and stability of the sliding fit between the door plate 20 and the door frame 10; and on the other hand, the T-shaped structure exhibits superior bending resistance in the vertical direction, enabling the at least ones sliding-guided structure 22 to withstand greater bending moments, and extending the service life of the at least ones sliding-guided structure 22.

In some embodiments, the automatic door device 300 further includes a cover housing 4. A mounting cavity 401 is formed with the cover housing 4 and the top beam 11. Specifically, the cover housing 4 is coupled to one side of the top beam 11 in the thickness direction Y of the door plate 20. The lifting structure 3 is mounted within the mounting cavity 401. The cover housing 4 and the at least one sliding-guided structure 22 are located on the same side of the door plate body 21. Specifically, the cover housing 4 and the at least one sliding-guided structure 22 are located on a front side of the doo plate body 21. Two ends of the cover housing 4 at a side adjacent to the top beam 11 are provided with two avoiding notches 402, respectively. The two side beams 12 are mounted at the two avoiding notches 402, respectively. A width of each of the two avoiding notches 402 in a thickness direction Y of the door plate 20 is less than a protrusion height of each of the at least one sliding-guided structure 22 relative to the door plate body 21. Consequently, on one hand, the lifting structure 3 is concealed within the mounting cavity 401, thereby protecting the lifting structure 3 from external environmental damage or interference; and on the other hand, the at least one sliding-guided structure 22 can prevent the door plate body 21 from separating from the door frame 10, thus enhancing the reliability and stability of the connection between the door plate 20 and the door frame 10. In the embodiment, each of the at least one sliding-guided structure 22 and the cover housing 4 are mounted on a front side of the door plate body 21, thus avoiding an issue of animal feces contaminating the sliding-guided groove 201 and affecting the smooth transmission between each of the at least one sliding-guided structure 22 and the door frame 10, and thereby facilitating user operation of the functional components mounted on the cover housing 4.

Each of the two side beams 12 includes a supporting portion 121 and a sliding-guided portion 122. The supporting portion 121 of each of the side beam 12 is configured to be mounted on the breeding house 100. In the same side beam 12, one end of the sliding-guided portion 122 is accommodated within the sliding-guided groove 201, and an another end of sliding-guided portion 122 is coupled to supporting portion 121. In other words, one end of the sliding-guided portion 122 of an associated side beam 12 is accommodated within the sliding-guided groove 201, and an another end of sliding-guided portion 122 of the associated side beam 12 is coupled to supporting portion 121. Each of the two side beams 12 is substantially Z-shaped in a cross-section in a thickness direction Y of the door plate 20. Consequently, on one hand, the Z-shaped side beam 12 distributes lateral loads through diagonal support, thus enhancing the shear deformation resistance of the door frame 10, and thereby extending the service life of the side beam 12; and on the other hand, the Z-shaped side beam 12 features a compact structure, thus enabling the door frame 10 to guide the door plate 20 within the narrow sliding-guided groove 201, thereby improving space utilization. A positioning groove 1201 is formed at a corner where the sliding-guided portion 122 is coupled to the supporting portion 121. The door plate body 21 extends into the positioning groove 1201, thus improving the precision of the alignment assembly between the door plate body 21 and each of the two side beams 12, thereby enhancing the reliability and stability of the relative movement between the door plate body 21 and each of the two side beams 12.

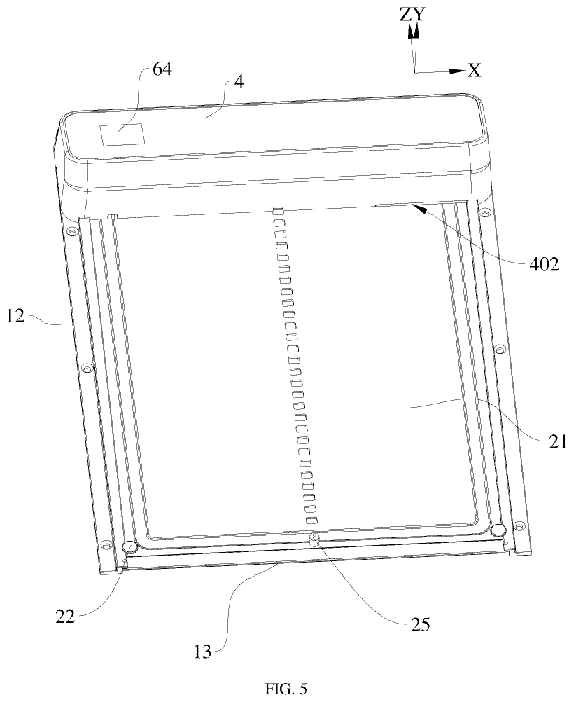

As illustrated to FIG. 3 and FIG. 5, FIG. 5 is a structural schematic view of a front view of the automatic door device 100 shown in FIG. 1 in which the automatic door device is in a closed state. In some embodiments, the door frame 10 further includes a bottom beam 13. The bottom beam 13 is arranged opposite to the top beam 11 are arranged opposite. Two ends of the bottom beam 13 in the lengthwise direction X of the door plate 20 are coupled to the two side beams 12, respectively. A bottom of the door plate body 21 is further provided with a stopping protrusion 25. The stopping protrusion 25 is configured to stop against the bottom beam 13. Consequently, on one hand, the overall structural strength of the door frame 10 is enhanced, thus improving the stability and reliability of the connection between the door frame 10 and the breeding house 100; and on the other hand, the stopping protrusion 25 is configured to limit a minimum height at which the door plate 20 descend relative to the door frame 10, thus preventing the door plate 20 from contacting the ground, preventing animal excrement from contaminating the door plate 20, preventing the door plate 20 from colliding with the bottom beam 13 of the door frame 10 after excessive movement during lifting or lowering, and thereby improving the operational safety of the automatic door device 300. Exemplarily, in the embodiment, the top beam 11, bottom beam 13, and two side beams 12 are coupled to form the entrance 101, thus enabling animals or caretakers to enter and exit the breeding house 100. Specifically, one end of each of the two side beams 12 is coupled to one end of the top beam 11, and an another end of each of the two side beams is coupled to one end of the bottom beam 13. Of course, in some embodiments, the bottom beam 13 may be omitted, that is, the door frame 10 only includes the top beam 11 and the two side beams 12.

In the embodiment, the stopping protrusion 25 and the cover housing 4 are located on the same side of the door plate body 21. The stopping protrusion 25 is configured to stop against the cover housing 4. When the door plate body 21 opens the entrance 101, the stopping protrusion 25 can stop against the cover housing 4. Consequently, the stopping protrusion 25 can also prevent the door plate body 21 from separating from the door frame 10, thus enhancing the reliability and stability of the connection between the door plate 20 and the door frame 10.

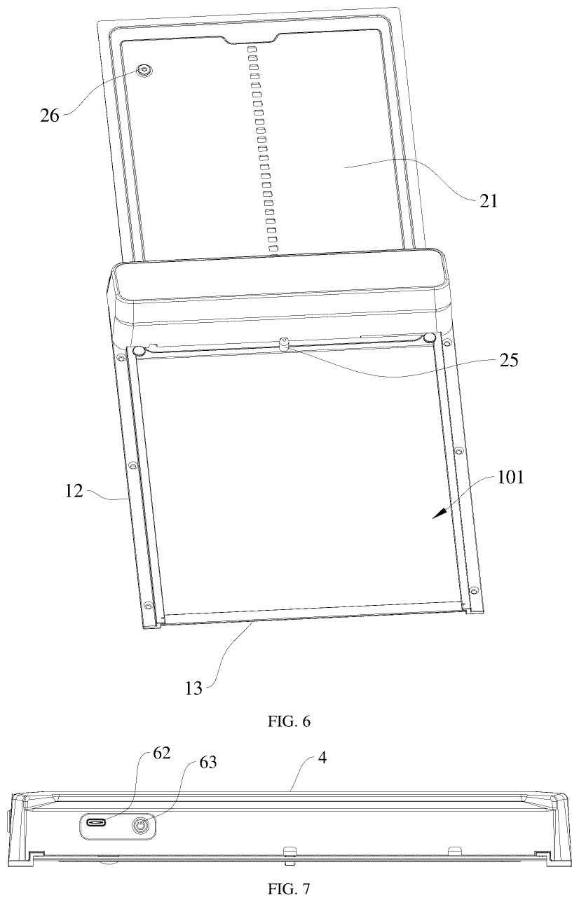

As illustrated to FIG. 3 and FIG. 6, FIG. 6 is a structural schematic view of a front view of the automatic door device 300 shown in FIG. 1 in which the automatic door device is in an open state. The automatic door device 300 further includes a first wireless control structure 5. The first wireless control structure 5 is mounted on the door frame 10. Specifically, the first wireless control structure 5 is positioned within the mounting cavity 401. The first wireless control structure 5 includes a position detector 6 and a first control board 51. The position detector 6 is connected to the first control board 51. The position detector 6 is configured to generate a sensing signal when the door plate body 21 moves relative to the door frame 10 to a closed position. The first control board 51 is configured to receive the sensing signal, and is configured to control the lifting structure 3 to stop working according to the sensing signal. The closed position refers to a position where the door plate 20 moves relative to the door frame 10 until the door plate body 21 closes the entrance 101. Consequently, the position detector 6 can detect the closed position, thus improving the accuracy and reliability of the sliding movement of door plate 20 relative to door frame 10, preventing a damage caused by excessive movement of door plate 20 relative to door frame 10, and thereby improving the operational safety of automatic door assembly 300.

Exemplarily, in the embodiment, the door plate body 21 is provided with a sensing member 26. The position detector 26 is mounted on the top beam 11. The position detector 26 is configured to sense the sensing member 26. Specifically, when the door plate body 21 moves relative to the door frame 10 toward the closed position, the position detector 6 senses the sensing element 26 to generate the sensing signal. The sensing member 26 is configured as a magnetic element, and the position detector 6 is configured as a Hall sensor. When the door plate 20 moves between the closing position and an open position relative to the door frame 10, the magnetic field detected by the Hall sensor changes. Consequently, the sensing member 26 and the position detector 6 perform non-contact detection, thus avoiding wear issues caused by physical contact between the position detector 6 and the door plate 20. Additionally, the Hall sensor has the characteristic of being insensitive to vibrations and electromagnetic noise, thereby improving detection performance. When the Hall sensor detects the magnetic induction strength of the magnetic component, the Hall sensor generates the sensing signal. At this moment, the Hall sensor can transmit the sensing signal to the first control board 51, and the first control board 51 can control the lifting structure 3 to stop a driving operation according to the received sensing signal. In some embodiments, the position detector 6 may be configured as, but is not limited to, a distance sensor, an optical coupling sensor, a pressure sensor, and the like. the distance sensor includes but are not limited to a displacement sensor, a proximity sensor, and an ultrasonic sensor, and the like.

In some embodiments, the automatic door device 300 further includes an energy storage member 61. The energy storage member 61 is electrically coupled to the first control board 51 and the lifting structure 3. The cover housing 4 is mounted on an outer side of the energy storage member 61. In other words, the energy storage member 61 is mounted within the mounting cavity 401. The energy storage member 61 can supply power to the lifting structure 3, the first control board 51, and other electrical components, thus simplifying the connection lines of the automatic door device 300, eliminating the need for external connection cables, and achieving a simple and aesthetically pleasing structure. The energy storage member 61 may include a battery or a capacitor. The energy storage member 61 may be configured as a rechargeable structure or a non-rechargeable structure, and the present disclosure does not make specific limitations.

As illustrated to FIG. 2, FIG. 3, and FIG. 7, FIG. 7 is a top view of the automatic door device 300 shown in FIG. 1. In some embodiments, the automatic door device 300 further includes a connecting interface 62. The connecting interface 62 is mounted on the cover housing 4. The connecting interface 62 may include, but is not limited to, a power interface 89, a communication interface, a functional expansion structure, and the like. Exemplarily, in the embodiment, the connecting interface 62 is configured as a power interface 89. The automatic door device 300 can be coupled to an external power source via the connecting interface 62. The external power source can charge the energy storage member 61 and also supply power to electrical components such as the lifting structure 3 and the first control board 51 of the automatic door device 300.

In some embodiments, the automatic door device 300 further includes a control switch 63. The control switch 63 is mounted on the cover housing 4. Exemplarily, when an operator operates the control switch 63, the automatic door device 300 can control the door plate 20 to open or close the entrance 101, thereby enhancing the safety of the automatic door device 300. The control switch 63 can be configured as a mechanical button or a touch button. In some embodiments, the touch button can also be configured as a fingerprint button, thereby reducing a risk of the automatic door device 300 being accidentally triggered.

In some embodiments, the automatic door device 300 further includes an indicating structure 64. The indicating structure 64 is mounted on the cover housing 4. The indicating structure 64 may include, but is not limited to, a speaker, a lighting structure, or a display structure, and the like. The indicating structure 64 promptly emits an alert sound or displays an alert image during the opening/closing process of the door plate 20 and in abnormal situations to alert the operator, thus enabling the operator to intervene in the automatic door device 300 in a timely manner. In the embodiment, the indicating structure 64 is configured as a display structure, thus enabling the indicating structure 64 to real-time display the operational status and key parameters of the automatic door device 300, and thereby facilitating the operator to monitor the situation at any time.

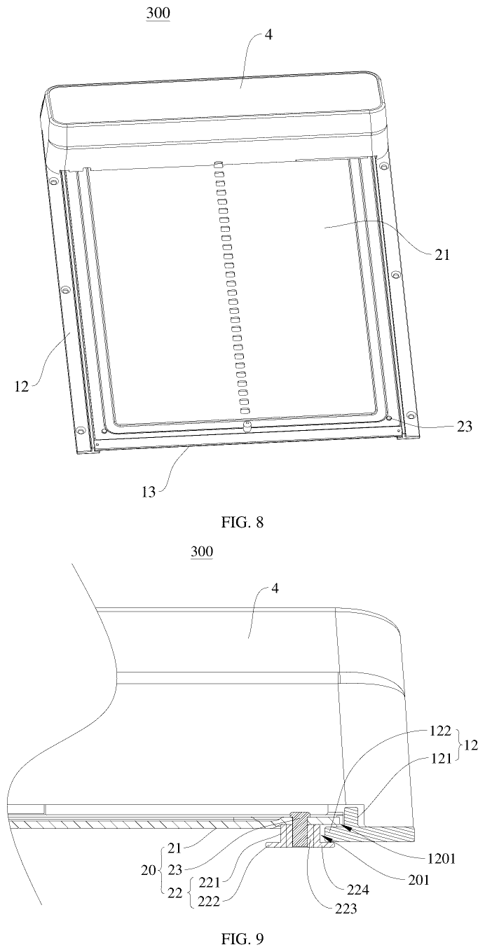

As illustrated to FIG. 2 and FIG. 8, FIG. 8 is a schematic view of a rear view of a partial structure of the automatic door device 300 in a closed state provided by a second embodiment of the present disclosure. In the second embodiment, a structure of the automatic door device 300 is similar to a structure of the automatic door device 300 in the first embodiment. The difference lies in the fact that, in the second embodiment, each of the sliding-guided structure 22 is rotatably coupled to the door plate body 21 by an associated mounting components 23. Consequently, on one hand, each of the at least one sliding-guided structure 22 and the associated side beam 12 are in rolling contact, thus reducing resistance, thereby reducing a friction force between each of the at least one sliding-guided structure 22 and the door frame 10, reducing the friction noise and vibration generated by the door plate 20 relative to the door frame 10 during lifting and lowering, and improving the smoothness and vibration of the door plate 20 during operation; and on the other hand, the rotational arrangement of each of the at least one sliding-guided structure 22 reduces edge stress, and the rotational guidance of each of the at least one sliding-guided structure 22 ensures uniform distribution of contact pressure, thus preventing localized wear and extending the service life of the at least one sliding-guided structure 22. The at least one sliding-guided structure 22 is mounted on a back side of the door plate body 21, thereby enhancing the aesthetic appeal of a front side of the door plate body 21. In other words, the at least one sliding-guided structure 22 and the cover housing 4 are positioned on opposite sides of the door plate body 21.

Of course, in some embodiments, the at least one sliding-guided structure 22 is mounted on the front side of the door plate body 21, thus avoiding contamination of the sliding-guided groove 201 by animal feces, which could affect the smooth transmission between the at least one sliding-guided structure 22 and the door frame 10, and facilitating user operation of functional components mounted on the cover housing 4.

Exemplarily, in the embodiment, each of the at least one sliding-guided structure 22 may be configured as a bearing. Compared to the sliding friction transmission between the sliding-guided structure 22 and the side beam 12, the rolling transmission between the bearing and the side beam 12 reduces power loss, lowers friction noise, minimizes wear, and enables the sliding-guided structure 22 to distribute concentrated loads across multiple contact points, thus reducing contact surface stress and extending service life. Exemplarily, each of the at least one sliding-guided structure 22 may be configured as a flange bearing. Specifically, the flange bearing includes an inner ring structure 223 and an outer ring structure 224. The inner ring structure 223 of each of the at least one sliding-guided structure 22 is fixedly coupled to the door plate body 21 by the associated mounting component 23, the outer ring structure 224 of each of the at least one sliding-guided structure 22 is rotatably mounted on an outer side of the inner ring structure 223. The outer ring structure 224 of each of the at least one sliding-guided structure 22 includes a bearing portion and a flange portion. In other words, the connecting portion 221 of each of the at least one sliding-guided structure 22 includes the inner ring structure 223 and the bearing portion of the outer ring structure 224. The extending portion 222 of each of the at least one sliding-guided structure 22 includes is configured as the flange portion of the outer ring structure 224. Consequently, when the door plate 20 moves relative to the door frame 10, the outer ring structure 224 of the bearing section can rotate relative to the inner ring structure 223, thereby distributing the load across the flange section of the flange bearing, reducing the risk of deformation of the side beams 12 and the bearing section, and extending the service life of the flange bearing. Of course, in some embodiments, the sliding-guided structure 22 may also be configured as a cylindrical bearing, roller, or other rolling structure, and the present disclosure does not make specific limitations. In other embodiments, the flange portion of the flange bearing is fixedly coupled to the door plate body 21, thereby enhancing the support rigidity of the bearing and effectively resisting lateral forces and overturning moments.

As illustrated to FIG. 8 and FIG. 9, FIG. 9 is a sectional view of a partial structure of the automatic door device 300 in FIG. 8. Exemplarily, in the embodiment, each of the two side beams 12 is substantially T-shaped in a cross-section in a thickness direction Y of the door plate 20. The sliding-guided portion 122 is coupled to a side of the supporting portion 121 adjacent to the door plate body 21. The sliding-guided portion 122 is configured to support the door plate body 21. Specifically, the door plate body 21 overlaps at a corner where the sliding-guided portion 122 and the supporting portion 121 are coupled. The supporting portion 121 is configured as an L-shaped structure, and the sliding-guided portion 122 is coupled to a corner of the supporting portion 121. A positioning groove 1201 is formed at a corner where the sliding-guided portion 122 is coupled to the supporting portion 121. The door plate body 21 extends into the positioning groove 1201. Consequently, on one hand, the loads are transmitted from a horizontally extending portion of the side beam 12 to a vertical intermediate portion of the side beam 12, a force transmission path of each of the two side beams 12 is more direct, thus reducing the likelihood of localized fatigue in the side beam 12; and on the other hand, the manufacturing process of the side beam 12 may be simplified, material waste may be minimized, the processing costs may be minimized, and assembly may be easy. Of course, in some embodiments, each of the two side beams 12 is substantially Z-shaped in a cross-section in a thickness direction Y of the door plate 20.

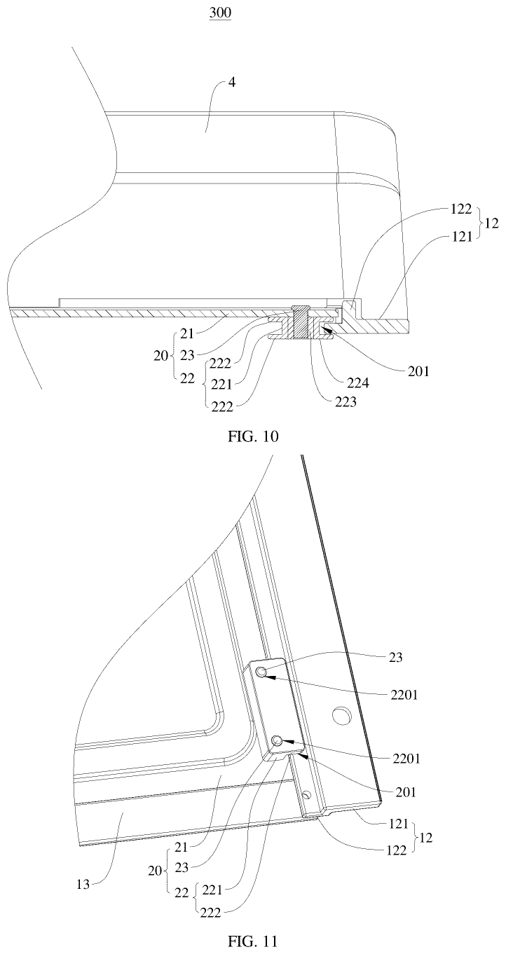

As illustrated to FIG. 8 and FIG. 10, FIG. 10 is a sectional view of a partial structure of the automatic door device 300 provided by a third embodiment of the present disclosure. In the third embodiment, a structure of the automatic door device 300 is similar to the structure of the automatic door device 300 in the second embodiment. The difference lies in the fact that, in the third embodiment, in the same sliding-guided structure 22, the extending portion 222 is provided as two in number. The two extending portions 222 are coupled to both ends of the connecting portion 221 respectively. The sliding-guided groove 201 is formed by the two extending portions 222 and the connecting portion 221. Consequently, on one hand, each of the at least one sliding-guided structure 22 is separated from the door plate body 21 and the door frame 10, thus reducing wear on the door plate body 21 and extending the service life of the automatic door device 300; and on the other hand, the sliding-guided groove 201 wraps around an edge of the associated side beam 12, thus preventing the at least one sliding-guided structure 22 from detaching from the door frame 10 during vibration, thereby enhancing the reliability of the automatic door device 300. Specifically, each of the at least one mounting member 23 is mounted between the door plate body 21 and the connecting portion 221 of the associated sliding-guided structure 22.

Exemplarily, in the embodiment, each of the at least one sliding-guided structure 22 is configured as a U-shaped bearing. The inner ring structure 223 of the U-shaped bearing is fixedly coupled to the associated mounting member 23, the outer ring structure 224 of the U-shaped bearing is rotatably mounted on an outer side of the inner ring structure 223. Consequently, on one hand, the U-shaped bearing can withstand loads from a plurality of directions, thus distributing stress, preventing localized wear, and extending the service life; and on the other hand, the sliding-guided groove 201 of the U-shaped bearing closely fits the associated side beam 12, thus reducing radial and axial clearance, and ensuring the linearity of the motion trajectory and repeatable positioning accuracy. In some embodiments, the sliding-guided groove 201 is configured as an arc-shaped groove, and the guide section 122 of each of the two side beams 12 is provided with a rounded corner structure, thereby reducing the risk of wear and collision between the door plate body 21 and the door frame 10. The sliding-guided groove 201 is configured as an annular groove. In other words, the sliding-guided groove 201 is arranged around a rotational axis of each of the at least one sliding-guided structure 22 in a circular pattern. Of course, in some embodiments, the at least one sliding-guided structure 22 may also be configured as a U-shaped roller; or the at least one sliding-guided structure 22 may be configured as a U-shaped bracket fixedly coupled to the associated mounting member 23. each of the two side beams 12 is substantially T-shaped in a cross-section in a thickness direction Y of the door plate 20. The positioning groove 1201 is formed at a corner where the sliding-guided portion 122 is coupled to the supporting portion 121, and both the door plate body 21 and the extending portion 222 extend into the positioning groove 1201.

As illustrated to FIG. 2, FIG. 11, and FIG. 12, FIG. 11 is a schematic view of a partial structure of the automatic door device 300 provided by a fourth embodiment of the present disclosure, and FIG. 12 is a cross-sectional view of a partial structure of the automatic door device 300 shown in FIG. 11. In the fourth embodiment, a structure of the automatic door device 300 is similar to the structure of the automatic door device 300 in the first embodiment. The difference lies in the fact that, in the fourth embodiment, the extending portion 222 extends from the connecting portion 221 toward the door frame 10. In other words, each of the at least one sliding-guided structure 22 is configured as an L-shaped structure. Consequently, the sliding-guided structure 22 is configured as the L-shaped structure, thus savings material, achieving lightweighting of the sliding-guided structure 22, facilitating processing, and enhancing the reliability and stability of the connection between each of the at least one sliding-guided structure 22 and the door plate body 21.

Exemplarily, in the embodiment, each of the at least one sliding-guided structure 22 is configured as an L-shaped adapter bracket. Both the connecting portion 221 and the extending portion 222 are configured as strip-shaped structures. Each of the at least one sliding-guided structure 22 is mounted on the door plate body 21 by a plurality of mounting members 23, thereby enhancing the reliability and stability of the connection between the sliding-guided structure 22 and the door plate body 21. Specifically, the door plate body 21 is provided with a plurality of through holes 203. Each connecting portion 221 of each of the at least one sliding-guided structure 22 is provided with a plurality of mounting holes 2201. The plurality of mounting members 23 are respectively passed through the plurality of through holes 203, respectively. The plurality of mounting members 23 are locked in the plurality of mounting holes 2201, respectively. The connecting portion 221 overlaps the sliding-guided portion 122 of the side beam 12 and is located at a corner where the supporting portion 121 is coupled to the sliding-guided portion 122.

Each of the two side beams 12 is substantially Z-shaped in a cross-section in a thickness direction Y of the door plate 20. In the same sliding-guided structure 22, the positioning groove 1201 is formed at a corner where the sliding-guided portion 122 is coupled to the supporting portion 121. The connecting portion 221 extends into the positioning groove 1201, thus facilitating the alignment and assembly of each of the at least one sliding-guided structure 22 with the associated side beam 12.

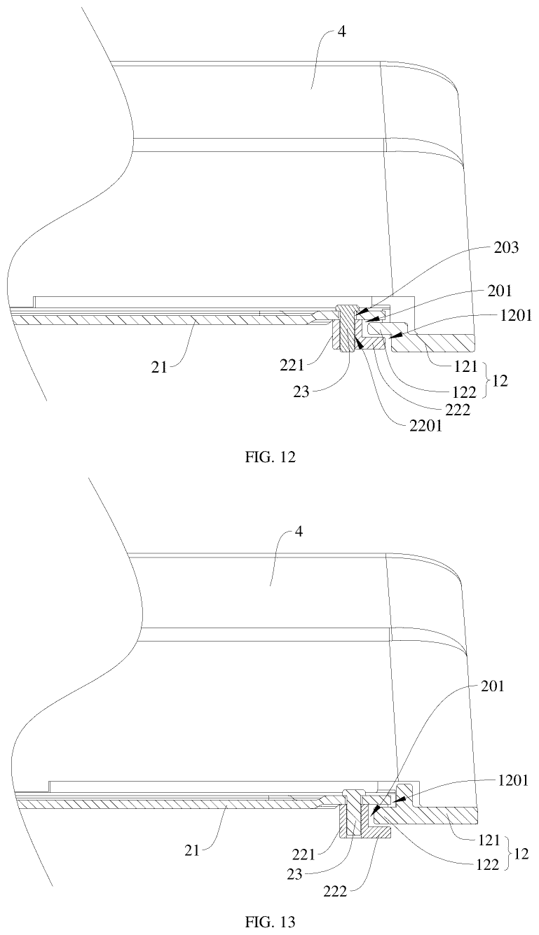

As illustrated to FIG. 12 and FIG. 13, FIG. 13 is a cross-sectional view of a partial structure of the automatic door device 300 provided by a fifth embodiment of the present disclosure. In the fifth embodiment, a structure of the automatic door device 300 is similar to the structure of the automatic door device 300 in the fourth embodiment. The difference lies in the fact that, in the fifth embodiment, each of the two side beams 12 is substantially T-shaped in a cross-section in a thickness direction Y of the door plate 20. In the same sliding-guided structure 22, the positioning groove 1201 is formed at a corner where the sliding-guided portion 122 is coupled to the supporting portion 121. The door plate body 21 extends into the positioning groove 1201, thereby improving the precision of the alignment assembly between the door plate body 21 and each of the two side beams 12, thereby enhancing the reliability and stability of the relative movement between the door plate body 21 and each of the two side beams 12.

It should be noted that structural elements in the automatic door device 300 of the second embodiment to the fifth embodiment that are identical to those described in the first embodiment may be referenced from the description of the automatic door device 300 in the first embodiment, and will not be repeated here. Exemplarily, the structure of the door plate 20 and the positional relationship between the door plate 20 and the door frame 10 described in the first embodiment apply to the second embodiment to the fifth embodiment, while the structure of the sliding-guided structure 22 and the installation method of the sliding-guided structure 22 relative to the door frame 10 described in the second to fifth embodiments apply to the first embodiment.

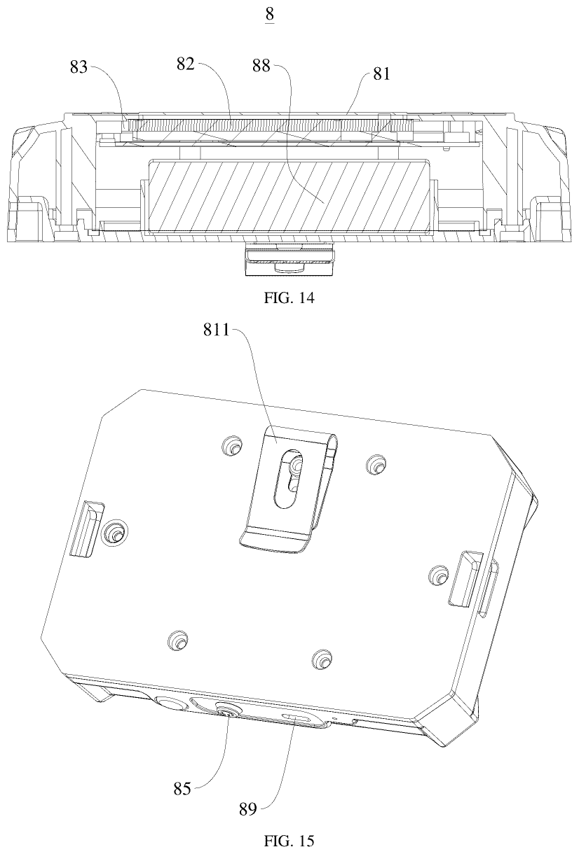

As illustrated to FIG. 1, FIG. 3, and FIG. 14, FIG. 14 is a cross-sectional view of a second wireless control structure 8 of the automatic door device 300 shown in FIG. 2. In some embodiments, the automatic door device 300 further includes a first wireless control structure 5 and a second wireless control structure 8. The first wireless control structure 5 is mounted on the door frame 10 of the automatic door 1. The first wireless control structure 5 is separately arranged from the second wireless control structure 8. The first wireless control structure 5 includes a first control board 51 and a first wireless communication module 52 connected with the first control board 51. The second wireless control structure 8 includes an outer casing 81, a second control board 82, a second wireless communication module 83, and a display screen 84. The second control board 82, the second wireless communication module 83, and the display screen 84 are mounted at the outer casing 81. The outer casing 81 is separable from the automatic door 1. The second control board 82 is connected with the second wireless communication module 83 and the display screen 84. The second wireless communication module 8 is configured to send a door-opening signal or a door-closing signal to the first wireless communication module 52. The first control board 51 is configured to receive the door-opening signal, and is configured to control the lifting structure 3 to drive the door plate 20 to open the entrance 101 according to the door-opening signal; or the first control board 51 is configured to receive the door-closing signal, and to control the lifting structure 3 to drive the door plate 20 to close the entrance 101 according to the door-closing signal, and the display screen 84 is configured to display a working state of the automatic door device 300. In some embodiments, the second wireless communication module 83 is configured as a SUB1G module. An operating frequency band of the second wireless communication module 83 includes at least one of 315 MHz, 433 MHz, 868 MHz, and 915 MHz. Consequently, on a first hand, the automatic door 1 is separately mounted from the outer casing 81, thus enabling the second wireless control structure 8 to be mounted in the farm management room or at a suitable location near the breeding house 100, and making it convenient for users to operate, on a third hand, the automatic door 1 is automatically controlled by the second wireless control structure 8 to open or close the door plate 20, thereby reducing the workload of livestock attendants who previously had to manually open and close the door frequently, and improving the efficiency and convenience of livestock management; and on a third hand, the second wireless communication module 83 is configured as a SUB1G module, thereby improving the transmission distance and wall-penetration capability of the second wireless communication module 83, thereby resolving the limitations imposed by existing wireless communication modules that rely on WiFi or Bluetooth for signal transmission, which restrict the distance and placement of the wireless control structure in usage scenarios, and thereby enhancing the portability of the second wireless control structure 8, and on a fourth hand, the second wireless control structure 8 is provided with the display screen 84, thus enabling users to monitor the surrounding environment and operational status of the livestock enclosure 100, thereby improving the user experience, and improving the management efficiency and operational safety of the automatic door device 300. Exemplarily, in the embodiment, the operating frequency band of the second wireless communication module 83 is configured as 433 MHz.

In some embodiments, the automatic door device 300 includes a plurality of automatic doors 1 and a plurality of first wireless control structures 5. Each automatic door 1 is provided with one lifting structure 3. The plurality of first wireless control structures 5 is mounted on the plurality of automatic doors 1, respectively. The second wireless communication module 83 in the second wireless control structure 8 may optionally establish a communication connection with at least one of the plurality of first wireless communication modules 52 corresponding to the plurality of first wireless control structures 5. Exemplarily, the second wireless communication module 83 may establish a communication connection with all or part of the plurality of first wireless communication modules 52, thus enabling the same first wireless control structure 5 to control different automatic doors 1 to open and close independently or selectively.

As illustrated to FIG. 2 and FIG. 15. FIG. 15 is a structural schematic view of a rear view of the second wireless control structure 8 of the automatic door device 300 shown in FIG. 2. In some embodiments, an outer side wall of the outer casing 81 is provided with a back clip 811. The back clip 811 is configured to removably mount the second wireless control structure 8 on an external device. The external device may be, but is not limited to, a farm management room or a suitable equipment near the breeding house 100, thus facilitating the assembly, replacement, maintenance, and other operations of the second wireless control structure 8.

In some embodiments, the second wireless control structure 8 further includes a pairing module 85. The pairing module 85 is coupled to the second control board 82. The pairing module 85 is configured to obtain and pair a first identity information of the first wireless communication module 52 and a second identity information of the second wireless communication module 83. The pairing module 85 is configured to obtain pairing results. The second control board 82 is configured to control connection status of the first wireless communication module 52 and the second wireless communication module 83 according to the pairing results obtained by the pairing module 85. Consequently, the second wireless control structure 8 can establish a communication connection with one or more automatic doors 1 by the pairing module 85, thus enhancing the flexibility and security of the automatic door device 300. The first identity information and second identity information can be factory-default settings or user-defined.

In some embodiments, the second wireless control structure 8 further includes a time adjusting module 86. The time adjusting module 86 is connected to the second control board 82. The second control board 82 is configured to receive timing signals transmitted by the time adjusting module 86 and to control the second wireless communication module 83 to transmit the door-closing signal or the door-opening signal to the first wireless communication module 52 according to the timing signals.

In some embodiments, the second wireless control structure 8 further includes a function key 87. The function key 87 is coupled to the second control board 82. The function key 87 includes, but is not limited to, parameter setting keys, brightness adjustment keys, display mode adjustment keys, and the like, thus achieving the multifunctionality and personalization of the second wireless control structure 8.

As illustrated in FIG. 2 and FIG. 14, in some embodiments, the second wireless control structure 8 further includes a power supply module 88. The power supply module 88 is coupled to the second control board 82, the second wireless communication module 83, and the display screen 84; and/or, the second wireless control structure 8 further includes a power interface 89, the power interface 89 is coupled to the second control board 82, the second wireless communication module 83, and the display screen 84. The power supply module 88 is configured as a battery or capacitor. The power supply module 88 may be configured as a rechargeable structure or a non-rechargeable structure, and the present disclosure does not make specific limitations. Exemplarily, in the embodiment, the second wireless control structure 8 simultaneously includes the power supply module 88 and the power supply interface 89. The power supply module 88 is configured as a rechargeable structure and is charged by the power supply interface 89.

In some embodiments, the second wireless control structure 8 further includes a prompt module 810. The prompt module 810 is coupled to the second control board 82 and is configured to indicate open or closed status of the automatic door 1. The prompt module 810 may include, but is not limited to, a speaker, a lighting structure, or a display structure, and the like. The prompt module 810 promptly emits an audible alert or displays prompt image information during the opening and closing process of the door plate 20 and in abnormal situations to alert the operator, thus enabling timely intervention with the automatic door device 300.

The above examples provide a detailed introduction to the embodiments of the present disclosure. Specific instances have been used herein to illustrate the principles and implementation methods of the present disclosure. The descriptions of the above embodiments are intended solely to aid in understanding the methods and core concepts of the present disclosure. Furthermore, for those skilled in the art, modifications to the specific implementation methods and application scope may be made based on the concepts of the present disclosure. In summary, the content of this specification should not be construed as limiting the scope of the present disclosure.

What is claimed is:

1. An automatic door device, which is applied to a breeding house, comprising:
an automatic door, wherein the automatic door comprises a door frame and a door plate; the door frame is configured to be mounted on an edge of a passageway opening of the breeding house; the door frame comprises a top beam and two side beams, the two side beams are coupled to two ends of the top beam in a lengthwise direction of the door plate, respectively, an entrance is formed by the two side beams and the top beam; the door plate comprises a door plate body and at least one sliding-guided structure, each of the at least one sliding-guided structure is coupled to the door plate body, a sliding-guided groove is formed by each of the at least one sliding-guided structure and the door plate body, and is slidingly cooperated with an associated side beam; or, each of the at least one sliding-guided structure is provided with a sliding-guided groove slidingly cooperated with an associated side beam; and
a lifting structure, wherein the lifting structure is mounted on the top beam, and the lifting structure is configured to drive the door plate body to drive the at least one sliding-guided structure to slide against the door frame to open or close the entrance.

2. The automatic door device of claim 1, wherein the door plate further comprises at least one mounting member, and each of the at least one sliding-guided structure is arranged independent from the door plate body, and is detachably mounted on the door plate body by an associated mounting member.

3. The automatic door device of claim 2, wherein each of the at least one sliding-guided structure is fixedly coupled to the door plate body by the associated mounting member; or, each of the at least one sliding-guided structure is rotatably coupled to the door plate body by the associated mounting member.

4. The automatic door device of claim 2, wherein each of the at least one sliding-guided structure is configured as a bearing.

5. The automatic door device of claim 2, wherein each of the at least one sliding-guided structure comprises a connecting portion and an extending portion;
in the same sliding-guided structure, one end of the connecting portion is coupled to the door plate body by the associated mounting member;
the extending portion is provided as one in number, the extending portion is coupled to an another end of the connecting portion, and the sliding-guided groove is formed by the extending portion, the connecting portion, and the door plate body; or,
the extending portion is provided as two in number, the two extending portions are coupled to two ends of the connecting portion, and the sliding-guided groove is formed by the two extending portions and the connecting portion.

6. The automatic door device of claim 5, wherein in the same sliding-guided structure, each extending portion extends from the connecting portion toward the door frame; or, each extending portion extends along a circumferential direction of the connecting portion.

7. The automatic door device of claim 1, wherein the automatic door device further comprises a cover housing, a mounting cavity is formed by the cover housing and the top beam, the lifting structure is mounted within the mounting cavity; the cover housing and the sliding-guided structure are located on the same side of the door plate body, two ends of the cover housing at a side adjacent to the top beam are provided with two avoiding notches, respectively;
the two side beams are mounted at the two avoiding notches, respectively, and a width of each of the two avoiding notches in a thickness direction of the door plate is less than a protrusion height of each of the at least one sliding-guided structure relative to the door plate body.

8. The automatic door device of claim 1, wherein each of the two side beams is Z-shaped or T-shaped in a cross-section in a thickness direction of the door plate, each of the two side beams comprises a supporting portion and a sliding-guided portion, the supporting portion of each of the two side beams is mounted on the breeding house; in the same side beam, one end of the sliding-guided portion is accommodated within the sliding-guided groove, and an another end of the sliding-guided portion is coupled to the supporting portion.

9. The automatic door device of claim 1, wherein the door frame further comprises a bottom beam, the bottom beam is arranged opposite to the top beam, two ends of the bottom beam in the lengthwise direction of the door plate are coupled to the two side beams, respectively; a bottom of the door plate body is further provided with a stopping protrusion, and the stopping protrusion is configured to stop against the bottom beam.

10. The automatic door device of claim 9, wherein the automatic door device further comprises a cover housing, a mounting cavity is formed by the cover housing and the top beam, the lifting structure is mounted within the mounting cavity, the stopping protrusion and the cover housing are located on the same side of the door plate body, and the stopping protrusion is further configured to stop against the cover housing.

11. The automatic door device of claim 1, wherein the at least one sliding-guided structure is arranged at a bottom of the door plate body in a height direction of the door plate.

12. The automatic door device of claim 1, wherein the door plate comprises two of the sliding-guided structures, and the two sliding-guided structures are arranged on two sides of the door plate body in a width direction of the door plate, respectively.

13. The automatic door device of claim 5, wherein the connecting portion is configured as a cylindrical structure.

14. The automatic door device of claim 5, wherein the door plate body is provided with at least one through hole, and each of the at least one sliding-guided structure is fixedly mounted at an associated through hole by the associated mounting member.

15. The automatic door device of claim 14, wherein the connecting portion of each of the at least one sliding-guided structure is provided with a mounting hole, each of the at least one mounting member comprises a locking portion and a stopping portion; in the same mounting member, the locking portion is locked in the mounting hole, and the stopping portion is coupled to one end of the locking portion and configured to stop against the door plate body.

16. The automatic door device of claim 1, wherein the automatic door device further comprises a first wireless control structure and a second wireless control structure, the first wireless control structure is mounted on the door frame and separately arranged from the second wireless control structure; the first wireless control structure comprises a first control board and a first wireless communication module connected with the first control board; the second wireless control structure comprises a outer casing, a second control board, a second wireless communication module, and a display screen;
wherein the second control board, the second wireless communication module, and the display screen are mounted at the outer casing, and the outer casing is separable from the automatic door, the second control board is connected with the second wireless communication module and the display screen, and the second wireless communication module is configured to send a door-opening signal or a door-closing signal to the first wireless communication module;
wherein the first control board is configured to receive the door-opening signal, and is configured to control the lifting structure to drive the door plate to open the entrance according to the door-opening signal; or the first control board is configured to receive the door-closing signal, and to control the lifting structure to drive the door plate to close the entrance according to the door-closing signal;
wherein the display screen is configured to display a working state of the automatic door device.

17. The automatic door device of claim 16, wherein the first wireless control structure further comprises a position detector, the position detector is connected with the first control board, the position detector is configured to generate an sensing signal when the door plate body moves relative to the door frame to a closing position, and the first control board is configured to receive the sensing signal, and is configured to control the lifting structure to stop working according to the sensing signal.

18. The automatic door device of claim 17, wherein the door plate body is provided with a sensing member, the position detector is mounted on the top beam, and the position detector is configured to sense the sensing member.

19. The automatic door device of claim 18, wherein the sensing member is configured as a magnetic element, the position detector is configured as a Hall sensor, and when the door plate moves between the closing position and an open position relative to the door frame, the magnetic field detected by the Hall sensor changes.

20. The automatic door device of claim 16, wherein an operating frequency band of the second wireless communication module comprises at least one of 315 MHz, 433 MHz, 868 MHz, and 915 MHz.
